(19) United States
(12) Patent Application Publication
(10) Pub. No.: US 2011/0309160 A1
(43) Pub. Date: Dec. 22, 2011

(54) ROTARY ATOMIZER OR MISTER

(75) Inventors: Rodney Kazem, South Australia (AU); Kaher Kazem, Pong Banglamung Chonburi (TH)

(73) Assignee: ROAIR PTY LTD, CLEARVIEW, S.A. (AU)

(21) Appl. No.: 13/133,334

(22) PCT Filed: Mar. 2, 2010
(86) PCT No.: PCT/AU10/00236

§ 371 Date: Jul. 29, 2011

(30) Foreign Application Priority Data
Mar. 10, 2009 (AU) 2009901013

(51) Int. Cl. B05B 3/08

(52) U.S. Cl. 239/231

(57) ABSTRACT

A rotary atomizer comprises of two main parts, a rotatable body and stationary body, wherein the rotatable body preferably consists of a cylinder or drum (7) for propelling water outwardly and number of atomizing parts (8 not indicated, 10) consisting of generally concentrically arranged atomizing rings (8) and/or vanes (10) for impinging and atomizing the propelled water droplets and also for generating a radial air flow (19). The stationary body preferably comprises of a number of atomizing parts (15, optionally 16) of concentrically arranged atomizing vanes also for impinging and atomizing propelled water droplets. The stationary and rotatable bodies are assembled together about an axis of rotation (17) and the sizing, spacing and diameters of each of the concentric impingement and atomizing parts (8, 15, 10, 16) arranged to prevent contact between the rotatable and stationary bodies and such that when moving radially outward from the centre, consecutive rotating impingement and atomizing parts (8, 10) are separated by a stationary impingement and atomizing part (15), thereby causing radially directed water droplets to be impinged by the successive rotating and stationary concentrically arranged impingement and atomizing parts (8, 15, 10, 16).

### FIELD OF THE INVENTION

This invention relates to rotary type atomizers or misters, primarily used for evaporative cooling and humidification devices.

### BACKGROUND OF THE INVENTION

Various types of evaporative cooling and humidification devices have been developed to add moisture to dry air. Air is usually passed through a wet saturated pad to cause evaporation and humidification of the air. Other forms of devices utilize nozzles to spray atomized mist into the air-stream. Pad type systems require regular replacement due to clogging and loss of efficiency over time, increasing cost. Nozzle type systems also require regular maintenance and are vulnerable to clogging, often requiring the need of water filtering and high pressure pumps to achieve fine mists suitable for evaporation, adding to cost.

In certain applications, rotary or sometimes referred to as centrifugal atomizers or misters are used to add moisture to the air. In such devices, water is propelled outwardly by a rotating plate or other body to impinge on a surface, where it is broken up into small droplets that are entrained in a stream of air and then discharged to the surroundings.

Currently known Rotary (or centrifugal) type atomizers utilized in evaporative cooling or humidification eliminate many of the disadvantages associated with wet pad and nozzle spray mist type systems, but generally need to be operated at high speeds to achieve sufficiently small droplets suitable for evaporation. This increases noise and requires the use of high speed motors, increasing complexity and cost. The droplets are generally of a broad spectrum of size, where the smaller droplets evaporate into the airstream and the larger droplets are not readily absorbed and are entrained in the airstream. This reduces efficiency and adds further complexity with the need for downstream water droplet eliminators to remove unwanted excess un-evaporated droplets. Known atomizers also have a tendency to become clogged with dust and other particles when they are used in industrial environments such as textile mills. Some of these disadvantages may limit the use of Rotary type atomizers as a cost effective alternative to wet pad and nozzle spray mist type systems.

It is a general object of the present invention to provide a much improved Rotary Atomizer that obviate's or mitigates some of these and other disadvantages of known Rotary atomizers.

### SUMMARY OF THE INVENTION

In accordance with the present invention, there is provided a Rotary Atomizer having two main parts; a body rotatable on an axis and a body stationary about the same axis.

The rotatable body consists of generally concentric impingement and atomizing parts for impinging supplied water and propelling outwardly by centrifugal force onto a generally concentric impingement and atomizing part of the stationary body that also provides clearance for outwardly movement of said droplets. This causes the droplets to strike the impingement surfaces and breakup into many small droplets and continue to move outwardly. A further generally concentric impingement and atomizing part is provided on the said rotatable body of a diameter greater than the concentric impingement and atomizing part of the stationary body, which strike the outwardly directed water droplets, which further breaks up into smaller droplets and also propel outwardly by centrifugal force. These droplets then may strike a further concentric impingement and atomizing part of the stationary body, which again breaks up said outwardly directed droplets, further enhancing the volume and density of the small water droplets.

At least one of the rotatable parts generates a radial or outwardly directed air flow, which mixes with the outwardly propelled water droplets further enhancing the efficiency and production of fine mist.

Additional generally concentric and alternating impingement and atomizing parts of the rotatable and stationary bodies may be utilized to further enhance the efficiency of production of small water droplets.

Due to the multiplication effect of outwardly propelled droplets being subjected to a series of large impingement forces from alternating rotating and stationary concentric impingement and atomizing parts, the present invention, is able to produce a fine mist or fog type discharge at lower speeds than conventional atomizers. This reduces the problem of wetting nearby surfaces and eliminates or reduces the need for filters or moisture eliminators to remove larger un-evaporated droplets.

Due to the lower speeds, noise is reduced considerably and allows for much simpler design and reduced cost of evaporative coolers and humidifiers.

It has been found that the rotary Atomizer of the present invention provides an effective solution to obviate or mitigate problems presented by known prior art rotary Atomizers, as described above.

### DESCRIPTION OF DRAWINGS

For a better understanding of the present invention and to show more clearly how it may be carried into effect, reference will be made to the accompanying drawings in which:

FIG. 1 is an oblique perspective view of the atomizer.

FIG. 2 is an oblique perspective view of a component of the atomizer of FIG. 1, which is referred to as the Rotating Body.

FIG. 3 is an oblique perspective view of an alternative design of the Rotating Body of FIG. 2.

FIG. 4 is an oblique perspective view of a component of the atomizer of FIG. 1, which is referred to as the Stationary Body.

FIG. 5 is an oblique perspective view, when viewed from above and to the side of the Stationary Body of FIG. 4.

FIG. 6 is an oblique perspective sectioned view of the Atomizer of FIG. 1, showing the relative relationship of the Rotating Body of FIG. 2 to the Stationary Body of FIGS. 4 and 5.

FIG. 7 is a cross section view of the Atomizer in FIG. 1, looking from the top, showing the relative relationship of the Rotating Body of FIG. 2 to the Stationary Body of FIGS. 4 and 5.

FIG. 8 is an enlarged detail view of one part of the cross section view of FIG. 7.

FIG. 9 is an oblique perspective view of a typical Evaporative cooler or Humidifier with one side of the case removed to reveal the internal components, including the Atomizer of FIG. 1.

### DETAIL DESCRIPTION OF THE INVENTION

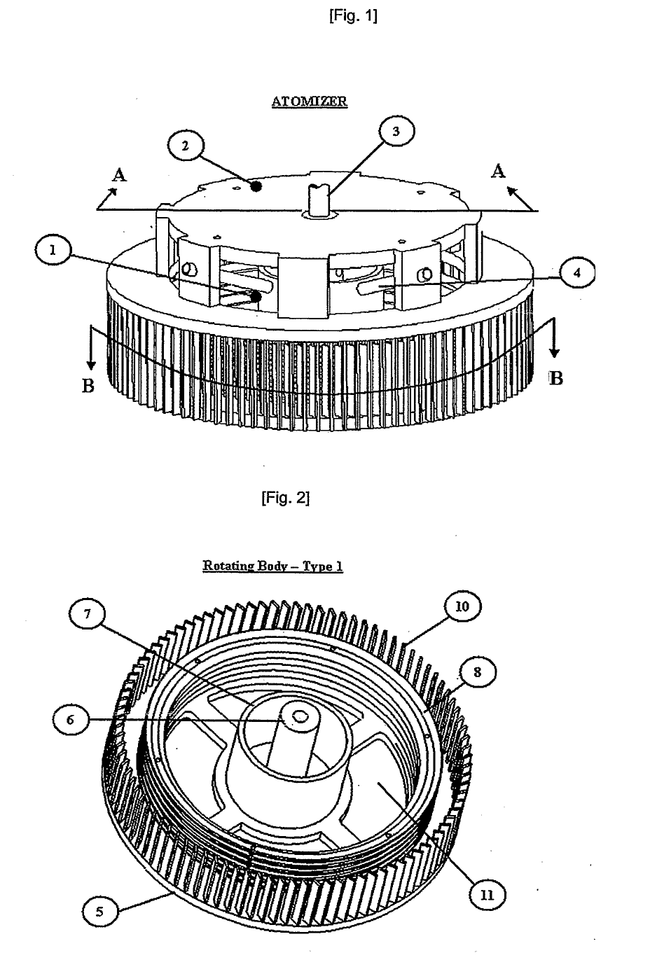

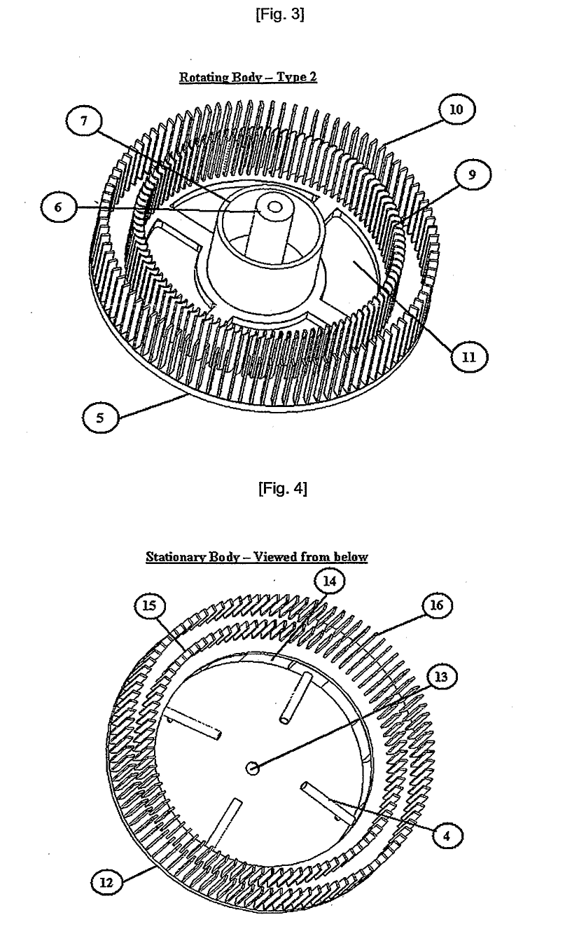

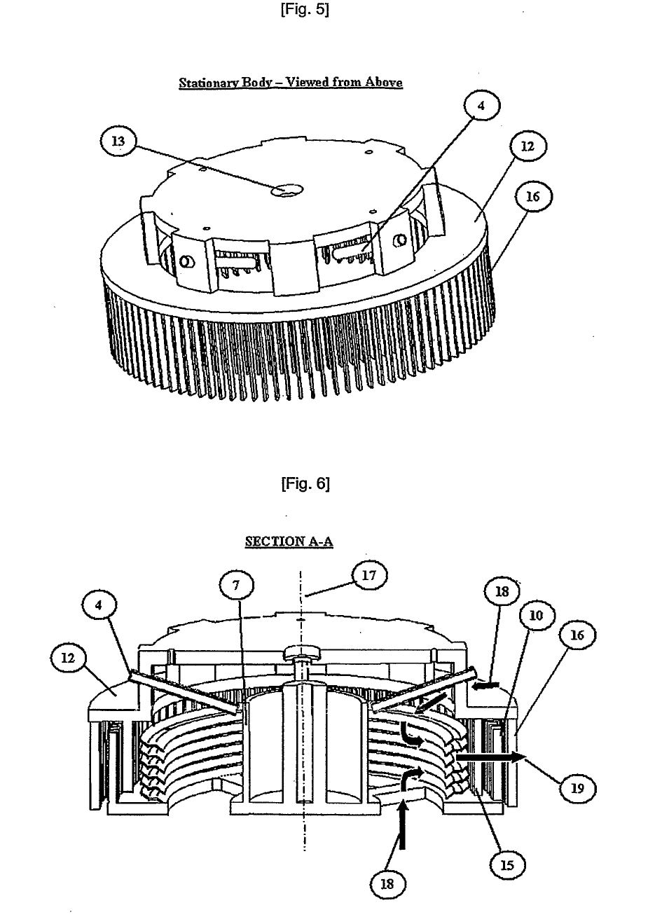

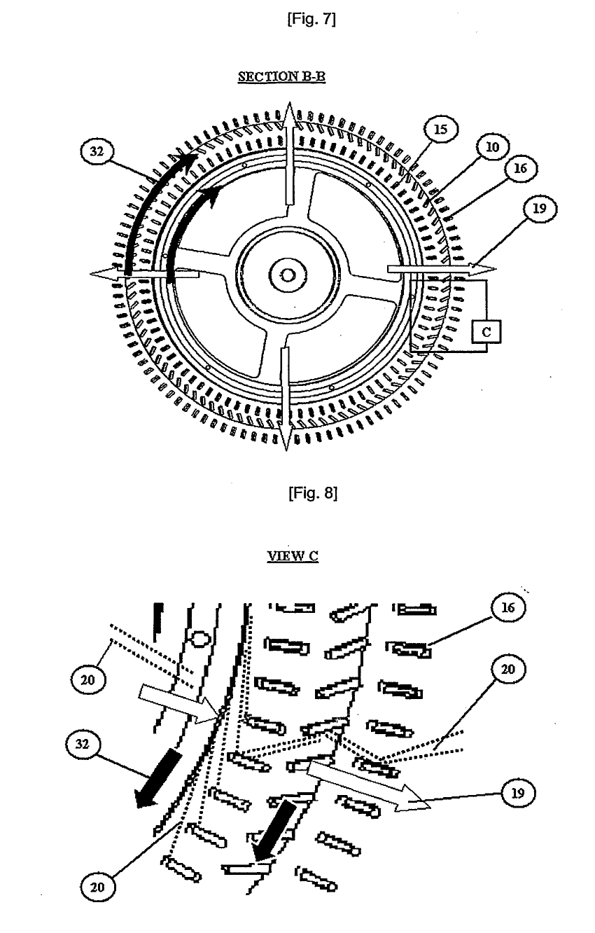

Referring to FIGS. 1-9, the Rotary Atomizer consists of two main parts, namely a Stationary Body 2 in FIG. 1, also shown in FIGS. 4, 5 and a Rotating Body 1 in FIG. 1, also shown in two preferable alternative methods in FIGS. 2,3.

The rotating body preferably consists of hub 6 and means for mounting to a rotating shaft 3, a cylinder or drum 7 and a series of impingement and atomizing parts 8 or 9 and 10. The cylinder or drum 7 is mounted to base 5. The first impingement and atomizing part 8 or 9 preferably consists of either concentrically arranged impingement and atomizing rings 8 or impingement and atomizing vanes 9, mounted to a base 5. The rings 8 are generally conical in shape and vanes 9 preferably curved to assist in water droplet impingement. A second atomizing stage 10 consisting of concentrically arranged impingement and atomizing vanes mounted to base 5. The spacing between the rings 8 or vanes 9,10 are arranged, such that to allow radially directed air flow 19 to pass through and to impinge radially directed water droplets 20 that is projected outward from the cylinder or drum 7. The base 5 is provided with air inlet ports 11.

The stationary body preferably consists of a series of concentrically arranged impingement and atomizing parts 15, 16 on a base 12 and also consists of water distribution tubes or channels 4 for supplying water and bearing 13 for supporting a rotating shaft 3. The base 12 has means for mounting to a motor case or other fixed structure and air inlet ports 14. The impingement and atomizing parts 15, 16 most preferably consists of concentrically arranged impingement and atomizing vanes.

In operation, a motor connected to the shaft 3, which is connected to hub 6, causes the said rotating body 1 to rotate 32 relative to the said stationary body, which is attached to the said motor case or structure fixed relative to the motor case. During rotation the impingement and atomizing vanes 10 cause air 18 to be drawn through ports 11, 14, and induce a radially (outwardly) directed airflow 19. Water is preferably directed through water channels or tubes 4 onto the rotating drum 7, which causes water droplets 20, by centrifugal forces to be thrown outward striking the first part impingement and atomizing rings 8 or vanes 9. The water droplets 20 are impinged by either the conical rings 8 or vanes 9 and flatten out under large inertial forces. Water can also be directed onto first part impingement and atomizing rings 8 or vanes 9 to achieve a similar effect. This causes very small droplets to discharge at the outer edge of the conical rings or vanes at high tangential speed by centrifugal force. In addition the radial airflow 19 passes through the said rings or vanes mixing with the water droplets. The high-speed water droplets then strike and are impinged by the stationary body first part impingement and atomizing vanes 15 causing the fine droplets to break up into many smaller droplets, again moving outwardly. While this is occurring significant mixing is occurring with the radial air stream 19. The outwardly projected small droplets continue to move radially outwards and are struck and impinged by the rotating body impingement and atomizing vanes 10, which again further breaks these droplets into smaller water droplets and again combining with the radial air stream 19 and propelling outwardly by centrifugal force. The water droplets, being propelled by the rotating body impingement and atomizing vanes 10, are then preferably impinged by a second impingement and atomizing part 16 of the stationary body.

A multiplication effect is caused by utilizing a series of alternating concentrically arranged rotating and stationary impingement and atomizing parts, whereby each part imparts greater impingement forces as the water droplets propagate radially outwards, thereby increasing the number and density of small droplets, greatly improving the efficiency of the atomizer even at low speeds.

The design is also scalable, by increasing the depth of the impingement and atomizing parts or length of vanes and/or diameters, greater water flow and volume of small droplet water mist generation is possible.

The design of the impingement and atomizing parts, shown in the accompanying drawings presents a most preferable design for enhancing efficiency, but not limited to in its application. Other types of impingement and atomizing parts may be used to replace the said vanes or said rings to effect an impingement surface and/or to cause outwardly directed water droplets by centrifugal force and may include concentrically arranged mesh or various shaped vanes.

Advantages of this Rotary Atomizer are, low cost simple design, high efficiency, high volume and density of small droplets even at lower speeds to conventional rotary atomizers promoting efficient evaporation into surrounding air stream. Also due to the radially generated air flow, may be used with or without additional fan assisted air flow.

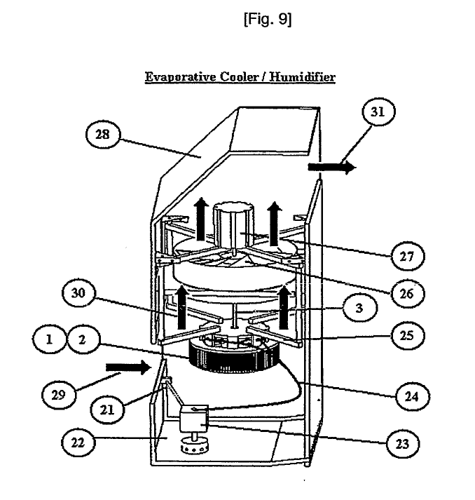

FIG. 9 is an oblique perspective view of a preferable design of an Evaporative cooler or Humidifier utilizing the Atomizer of this present invention. One side of the case in FIG. 9 is shown removed to reveal the internal components. A motor 27 and fan 26 are positioned to enable an airflow path 30 from a fresh air inlet 29 to a conditioned air outlet 31. The atomizer 1, 2 is connected to the said motor via a shaft 3 and mounted to the case by struts 25. The said atomizer is placed in the center of the airflow path and during operation discharges fine mist water droplets 20 outwards in radial direction. Water droplets in a fine mist are carried by the air stream 30 and evaporated. Un-evaporated droplets generally strike the case wall 28 and drain back to the sump 22. The sump is furnished with a drain with a suitable water valve and float 21 to facilitate filling and controlling water level in the sump. A low-pressure water pump 23 is located in the bottom of the sump 22 and is connected to the said atomizer via a water flow control and water tube 24.

While the above describes a typical application of the said rotary atomizer, it is not intended to be exhaustive. The rotary atomizer may be powered by different methods, mounted in various orientations and also may be used in various other fluid atomizing or misting applications other than generally for humidification and cooling.

It is to be understood that the invention is not limited in it's application to the details of an arrangement of the components illustrated in the accompanying drawings, since the invention is capable of other embodiments and of being practiced or carried out in various ways within the scope of the claims. It is also understood that the terminology employed herein is intended for the purpose of description and not limitation. In it's broadest scope, the present invention encompasses many modifications and alternative embodiments, appropriate for different circumstances.

1. A rotary atomizer, comprising;
a rotating body and stationary body each positioned on the same axis of rotation, wherein the rotating body is attached to a rotatable shaft and drive means for rotating the said shaft and the stationary body attached to a stationary structure relative to the said rotatable shaft so as to cause the rotating body to rotate about the said axis of rotation and the stationary body to remain stationary about said the axis of rotation;
wherein said rotating body consists of a means for attachment to the said rotating shaft;
wherein the rotary atomizer consists of a means to supply and direct water onto said rotating body;
wherein said rotating body consists of at least two generally concentric impingement and atomizing rotatable parts about the said axis of rotation, wherein the first part has the smallest diameter and the second part with a diameter greater than the first and each successive part has a diameter greater than the preceding part, wherein each said part provides a means to allow outwardly directed airflow and small water droplets to pass through and impingement surfaces for breaking up supplied and/or outwardly projected water and for propelling outwardly small water droplets by centrifugal force;
wherein said rotating body may consist of a further rotatable part for propelling supplied water, by centrifugal force, outwardly or generally radially in the form of droplets towards the said first impingement and atomizing part of the rotating body;
wherein said rotating body comprises a rigid base connecting all the parts of the rotating body;
wherein said stationary body comprises at least one generally concentric impingement and atomizing part about said axis of rotation, which provides a means to allow radially directed air flow and small water droplets to pass through and impingement surfaces for breaking up said outwardly propelled water droplets projected from the said rotating body impingement and atomizing parts into smaller droplets;
wherein said stationary body comprises a rigid top connecting all parts of the stationary body and means for mounting to a stationary structure or motor case;
wherein stationary and rotating bodies are assembled together on the same said axis of rotation and the diameters and sizing of the said concentric parts of the said rotating and stationary bodies are arranged such that while moving radially outward from the axis of rotation, a said first rotating impingement and atomizing part is immediately followed by and adjacent to a first stationary impingement and atomizing part, which is followed by and adjacent to the said second rotating impingement and atomizing part and then followed by and adjacent to a second stationary impingement and atomizing part when two stationary parts are used and if more rotatable and stationary impingement and atomizing parts are used then the sequence continues;
wherein sizing, shape and position of each of the said impingement and atomizing parts of the said rotating and stationary bodies are arranged to achieve optimal close separation without causing contact between the parts of the rotating and stationary bodies during rotation.

2. A rotary atomizer as in claim 1, wherein, when water is supplied to the said rotating body during rotation, causes, by centrifugal forces, water to propel outwardly and also supplied and/or outwardly propelled water to impinge, thin and discharge from the impingement surfaces outer edges of the first said impingement and atomizing part of the rotating body in the form of very small droplets at high tangential velocity, which then strike the surfaces of the said first impingement and atomizing part of the said stationary body with high force, which breaks up the droplets further and continue to project outwardly, which then are struck by and impinged by the said second impingement and atomizing part surfaces of the rotating body, which further breaks up the droplets and discharge from the impingement surfaces into even smaller droplets and continue to project generally outwardly, which then, if a successive impingement and atomizing part is used, would strike and impinge on the said second impingement and atomizing part of the said stationary body at high force, which further enhances the production and outwardly projection of smaller droplets, thereby increasing the volume and density of the smaller droplets;
wherein water droplets projected outwardly are generally subjected to at least two large impingement forces from the relative movement of rotating and stationary impingement and atomizing parts of the said rotating and stationary bodies, where the first is from small water droplets being projected from the said first rotating impingement and atomizing part and impinged by the surfaces of the said first impingement and atomizing part of the stationary body and the second from the outwardly projected water droplets from the said first impingement and atomizing part of the stationary body being struck and impinged by the surfaces of the said second impingement and atomizing part of the said rotating body, whereby, the second impingement force is greater than the first due to the increased relative tangential speed between the rotating and stationary impingement and atomizing parts;
wherein additional successive generally concentric and alternating rotatable and stationary parts may be used, where each successive part imparts greater force on the water droplets due to the increased relative tangential speed between the rotating and stationary impingement and atomizing parts.

3. The rotary atomizer as in claim 2, wherein at least one of the said rotatable parts of the said rotating body consists of a means to generate and cause a radially outward projected airflow during rotation.

4. A rotary atomizer as in claim 2, wherein the said first impingement and atomizing part of the said rotating body consists of at least one or more rings, wherein each of the said rings preferably are: generally conical in shape or having a multiplicity of conical sections of increasing diameters, and positioned generally concentrically about the said axis of rotation, and positioned with spacing between the rings.

5. A rotary atomizer as in claim 3, wherein the said first impingement and atomizing part of the said rotating body consists of vanes that are generally arranged concentrically about the said axis of rotation.

6. A rotary atomizer as in claim 5, wherein the said second impingement and atomizing part of the said rotating body consists of vanes that are generally arranged concentrically about the said axis of rotation.

7. A rotary atomizer as in claim 6, wherein if the said rotating body consists of more than two impingement and atomizing parts, then each further part may consist of the said vanes.

8. A rotary atomizer as in claim 2, wherein, the said rotatable part for propelling supplied water outwardly of the rotating body consists of a cylinder or drum generally concentric to the said axis of rotation attached to the said base, which provides a means for causing water droplets to be thrown out radially, when water is supplied and directed onto said cylinder or drum while rotating.

9. A rotary atomizer as in claim 2, wherein water may be supplied and directed to the said first impingement and atomizing part of the said rotatable body, so as to cause the supplied water to be propelled outwardly into smaller water droplets by centrifugal force, in addition to, or as an alternative to the said rotatable part for propelling water outwardly.

10. A rotary atomizer as in claim 2, wherein each of the stationary body said impingement and atomizing parts consists of vanes that are generally arranged concentrically about the said axis of rotation.

11. A rotary atomizer as in claim 2, wherein the said rigid base of the rotating body and/or said rigid top of the said stationary body are provided with inlet ports as a means to allow air to flow into the center of the body and then directed radially outward through each of the alternating impingement and atomizing parts, during rotation.

12. A rotary atomizer as in claim 2, where a fluid spreader and/or fluid distribution tubes are mounted to or are integral on the said stationary body so as to cause water to be distributed evenly onto the said rotating body.

13. A rotary atomizer as in claim 5, wherein each of the said vanes are shaped, sized and positioned to optimize air flow, noise reduction and impingement and atomization of water droplets and preferably are: rectangular in shape with an inner and outer edge generally parallel to the said axis of rotation, and positioned with the said inner edge closer to the said axis of rotation than the outer edge, and may be aligned or angled or curved along the radii that extends perpendicular from the said axis of rotation, and positioned concentrically about the axis of rotation with spacing to approximately the vane width.

14. A rotary atomizer as in claim 2, that may be constructed of various materials including and not limited to injection moulded plastics.

15. A rotary atomizer as in claim 2, that may be used for the atomization of fluids other than water.

16. A rotary atomizer as in claim 1, wherein said drive means includes a motor.

17. A rotary atomizer as in claim 2, where it is attached to a fan or used in conjunction with a fan to disperse generated mist in various airflow patterns and velocities.

18. A rotary atomizer as in claim 6, and detailed in drawings, FIGS. 1,2,3,4,5,6,7,8 and 9.
